(19) United States
(12) Patent Application Publication
(10) Pub. No.: US 2007/0034116 A1
(43) Pub. Date: Feb. 15, 2007

(54) Silica sols with controlled minimum particle size and preparation thereof

(76) Inventor: Dennis L. Mac Donald, Wheaton, IL (US)

Correspondence Address: Andrea C. Walsh;Patent and Licensing Department, Nalco Company, 1601 West Diehl Road, Naperville, IL, 60563-1198, US

(21) Appl. No.: 11/200,998

(22) Filed: Aug. 10, 2005

(51) Int. Cl. C04B 35/66; B28B 7/36; B24D 3/02

(52) U.S. Cl. 106/38.27; 51/308; 51/298; 106/481; 423/339

(57) ABSTRACT

Colloidal silica having an increased particle size and narrow particle size distribution is disclosed. A method for continuously producing the desired colloidal composition is disclosed comprising the steps of providing preformed silica particles having a surface area which controls the particle size of the colloidal silica product, adding a feed silica comprising an alkaline solution and silicate at a feed rate which is less than a nucleation rate, and increasing the feed rate as the feed silica is added wherein the feed rate is less than the nucleation rate.

### FIELD OF INVENTION

The present invention relates to colloidal silica sols having a controlled particle size prepared by a continuous process. In particular, this invention relates to silica sols having a pre-determined minimum particle size and desirable particle size distribution curve prepared without the use of multiple reactors.

### PROBLEM TO BE SOLVED

Recently, there has been an increased demand for colloidal silicas with a large average particle diameter (>about 25 nm). In many applications, e.g. in the polishing of silicon wafers, the effectiveness of the product correlates with the size of the silica particles which are colloidally dispersed in the liquid carrier. Due to the increased importance of silica sols containing large particles, many attempts have been made to identify economical and reliable method to prepare industrially useful colloidal silicas. As a result of these endeavors, products with average particle diameters of up to 36 nm have come onto the market. The preparation of these particles have involved complicated, multi-stage reactors which are economically undesirable.

In addition to the economical and technical disadvantages of multi-stage processes to produce silica sols of industrial applicability, current methods for growing colloidal silica particles do not produce larger particles that are uniform in size. Because of the importance in consistency of electrical properties in the manufacture of silicon wafers, it would be useful to be able to produce uniform size colloidal silica particles. Current methods do not produce particles of uniform size because the particles are grown at a rate which causes nucleation of the colloidal silica particles. Methods to produce uniform size colloidal silica particles have been found to be unusable for the production of larger particles because this process requires an impractical growth time due to the limitations on how the particles are grown.

Methods for preparing colloidal silicas that permit the direct preparation of this type of particle size (>25 nm) from acidic fresh sol in a simple and economically viable, continuous method would be highly desirable.

### SUMMARY OF THE INVENTION

Industrially-desired colloidal silica particle compositions having an increased uniform particle size and narrow particle size distribution are described.

The colloidal particles have a controlled minimum particle size and are produced by a method wherein preformed silica sol particles of predetermined minimum particle size are added to a single agitated, heated reactor; feed silica comprising an alkaline agent and silicic acid are to the reactor; at a rate which is less than a rate of nucleation of the colloidal silica; wherein the minimum particle size of the resulting colloidal silica is controlled by the particle size of the preformed silica sol.

The colloidal thus produced have wide industrial applicability.

### BRIEF DESCRIPTION OF THE INVENTION

“About” means within 50%, preferably within 25%, and more preferably within 10% of a given value or range. Alternatively, the term “about” means within an acceptable standard error of the mean, when considered by one of ordinary skill in the art.

As used herein, the term “colloidal silica composition” and other like terms including “colloidal”, “sol”, and the like refer to an aqueous two-phase system having a dispersed phase and a continuous phase. The colloids of the present invention have a solid phase dispersed or suspended in a continuous or substantially continuous liquid phase, typically an aqueous solution. Thus, the term “colloid” encompasses both phases whereas “colloidal particles” or “particles” refers to the dispersed or solid phase.

“Feed silica” comprises silicic acid and an alkaline agent.

“Nucleation rate” s the feed rate which causes nucleation of the colloidal silica particles

The term “stable” means that the solid phase of the colloid is present, dispersed through the medium and stable throughout this entire pH range with effectively no precipitate.

“Doping” refers to a process of incorporating silicic acid with a metal component dispersed into the framework of colloidal silica.

“Heel” refers to an aqueous basic solution in the doping process that at least includes a quaternary amine or an alkaline agent.

Methods for producing uniform size colloidal silica particles includes the steps of providing preformed silica particles having a predetermined particle size, adding an alkaline agent and a silicic acid to produce a feed silica which is added at a feed rate which is less than a nucleation rate which would cause nucleation of the preformed colloidal silica particles, and increasing the feed rate as the feed silica is added wherein the feed rate is less than the nucleation rate.

Applicant has discovered that the particle size distribution of these colloidal silica compositions can be precisely controlled in a single reactor continuous process in a manner previously thought to be impractical. By controlling the rate of the feed silica such that a certain maximum amount is fed as a function of specific surface area, so that the feed rate is always less than the nucleation rate. The nucleation rate is the feed rate which would cause nucleation of the colloidal silica particles. The feed rate is preferably 10.0 grams of silica, as SiO2 per 1,000 meters squared of surface area per hour at 90 degrees Celsius, so that nucleation is avoided entirely. In this manner, colloidal silica can be “grown” to any desired particle size, maintaining a narrow particle size distribution, while avoiding nucleation of new particles. By monitoring the feed rate, the accretion of resulting colloidal silica can be maximized and therefore, the production of the silica can be maximized.

Standard practice is to produce colloidal silica particles using a feed rate that is above the nucleation rate. Because this feed rates causes nucleation of the silica particles, the distribution of the particle sizes is large. However, using a feed rate that is below the nucleation rate, uniform colloidal silica particles can be produced.

It should be appreciated that more than one reactor can be used to form the inventive product since Applicant has discovered that the particle size and narrow size distribution of the product is controlled by the parameters identified above. As such, the invention encompasses the idea of multiple reactors.

The average particle size and particle size distribution of the preformed silica sol is identified at the initial stage of the process since the particle size of the resulting continuous colloidal silica is dependent on these parameters. Increasing the particle size of the premade silicic acid increases the average particle size of resulting colloidal silica.

The silicic acid solution can be prepared by passing a sodium silicate solution through a bed of H⁺-cation-exchange resin. The resulting deionized silicic acid solution tends to be quite reactive and is typically kept cooled to retard polymerization. Upon addition of the silicic acid solution to the alkaline solution to form the “feed silica” or heel.

The heel or feed silica contains alkaline agents, such as NaOH, KOH, NH₄OH, the like, and combinations thereof.

It should be appreciated that any suitable type of silicic acid solution can be utilized.

In another embodiment of the present invention, silicic acid is utilized to incorporate or disperse a metal component into the framework of colloidal silica (i.e., doping). The method includes preparing a heel. The heel includes an aqueous solution that at least includes a quaternary amine as defined herein or an alkaline agent. Suitable alkaline agents include, for example, NaOH, KOH, NH₄OH, the like and combination thereof. The silicic acid solution (can be prepared as previously discussed or other suitable manner) is reacted with a cationic metal component to form a metal silicate solution, represented chemically below:
H₄SiO₄₊M^{x+}→[x(H₃SiO₄⁻)−M^{x+}]₊xH⁺
The metal silicate solution is subsequently added to the heel to form the colloid.

During particle formation, the OH⁻ present in the heel catalyzes the copolymerization of the cationic metal component and silicate (SiO₄⁻) from the silicic acid. This produces a colloid with the metal dispersed within the silicate (i.e., incorporated into the particle framework as discussed above), such as having a homogenous distribution of the metal component throughout the entire solid phase of the colloid.

Colloidal silica has long been successfully used for polishing various materials, such as silicon, gallium arsenide, indium phosphide and titanium, to form a super-smooth and scratch-free surface finish. Colloidal silica slurries used for chemical-mechanical polishing (CMP) typically include aqueous colloidal silica with an etchant (oxidizer) as a polishing promoter. Various kinds of chemicals are used in colloidal silica slurries for different polishing applications to achieve either a high material removal rate or better polished surface finishes with fewer polish defects.

A polishing composition for the uses described above may comprise a polymeric core surrounded by embedded inorganic particles of colloidal silica, for polishing electronic materials, magnetic materials, optical materials, and the like. The embedded silica particles may contain aluminum.

A further application of the colloidal silica composition is in investment casting. The process utilizes a water based slurry comprising a colloidal silica for use as backup coat on a wax model. The slurry is utilized as a backup coat on a wax model used in a lost wax investment casting technique.

According to this synthesis procedure pursuant to an embodiment, metal silicate colloids of the present invention can have a metal content from about 0.0001% to about 2% by weight based on silica. The metal silicate colloids of the present invention are amorphous and generally spherical in shape, wherein the particles have an effective diameter or particle size from about 2 nm to about 1000 nm in an embodiment. The metal silicate colloids are stable at a pH range from about 1 to about 14, exhibiting effectively no precipitation in this range. The skilled artisan will appreciate that the size of the colloidal particles can be adjusted by varying the addition time of the metal silicate solution to the heel.

### EXAMPLES

Preparation of a Metallosilicate

Silica sol, having identified parameters, is diluted to the desired content of SiO₂ using deionized water. This diluted solution is treated with concentrated soda water glass containing SiO2 and Na₂ O corresponding to a desired ratio by weight at room temperature and with stirring. This sol is placed in the reactor. Silicic acid and an alkaline agent (feed silica or heel) are added to the reactor until steady state with regard to pH and average residence time are achieved. The feed silica is added at a feed rate which is less than a nucleation rate which would cause nucleation of the preformed colloidal silica particles, and increasing the feed rate as the feed silica is added wherein the feed rate is less than the nucleation rate.

A metal and stabilizer is then added to the reactor to form a metallosilicate colloid with desired particle size.

It, thus, will be appreciated that the objects of this invention have been fully and effectively accomplished. It will be realized, however, that the foregoing preferred specific embodiment has been shown and described for the purpose of this invention and is subject to change without departure from such principles. Therefore, this invention includes all modifications encompassed within the spirit and scope of the following claims.

1. A method for continuously producing colloidal silica particles having a controlled minimum particle size comprising the steps of:
a) providing a preformed silica sol particles of predetermined minimum particle size to at least one agitated, heated reactor;
b) adding feed silica comprising an alkaline agent and silicic acid to the reactor; at a rate which is less than a rate of nucleation of the colloidal silica;
wherein the minimum particle size of the resulting colloidal silica is controlled by the particle size of the preformed silica sol.

2. The method of claim 1, wherein the preformed silica sol has a narrow particle size distribution.

3. The method of claim 1, wherein the minimum particle size and particle size distribution of the resulting colloidal silica are controlled by the preformed silica sol.

4. The method of claim 1, wherein the silica feed rate is dependent on the reactor volume.

5. The method of claim 1, wherein the characteristics of the resulting colloidal silica is dependent on the rate of the feed silica.

6. The method of claim 5, wherein the rate of the feed silica is maintained below the nucleation rate of the colloidal silica particles.

7. The method of claim 1, wherein the reactor is held at a constant volume by continuous removal of the resulting colloidal silica from one or more reactors.

8. The method of claim 7, wherein the reactor volume is directly proportional to the rate of the feed silica.

9. The method of claim 1, wherein the rate of adding the feed silica is adjusted as a function of the total colloidal silica surface area.

10. A method for continuously producing colloidal silica particles having a desired particle size and particle size distribution comprising:
(a) identifying the desired size and distribution of the particle size of the colloidal silica;
(b) providing a preformed silica sol particles of predetermined minimum particle size to at least one reactor;
(c) adding feed silica comprising silicic acid and an alkaline agent to the colloidal silica particles at an addition rate sufficient to prevent nucleation of new silica particles;
(d) continuously adjusting the feed to increase the size of the colloidal silica particles and prevent nucleation of new silica; and
(e) maximizing the amount of colloidal silica particles produced.

11. The method of claim 10, wherein the size of colloidal silica particles produced is uniform.

12. The method of claim 10, further comprising adding a metal to the colloidal silica.

13. The method of claim 14, further comprising adding a metal to the colloidal silica.

14. A colloidal silica composition optionally comprising a metal having an increased particle size and narrow particle size distribution.

15. A colloidal silica composition produced by a continuous process in at least one reactor, the process compromising adding preformed silica sol particles of predetermined minimum particle size to the reactor, adding a feed silica comprising silicic acid and an alkaline agent to the colloidal silica particles at an addition rate sufficient to prevent nucleation of new silica particles; continuously adjusting the feed to increase the size of the colloidal silica particles and prevent nucleation of new silica; and maximizing the amount of colloidal silica particles produced.

16. A colloidal silica composition produced by the method of claim 1.

17. A colloidal silica composition produced by the method of claim 10.

18. A colloidal silica composition produced by the method of claim 13.

19. A colloidal silica composition of claim 14 useful in chemical mechanical polishing, wafer polishing, catalyst supports, investment casting or refractories.

20. A polishing composition comprising a polymeric core surrounded by embedded inorganic particles comprising the composition of claim 14.

21. A water based slurry for use as a backup coat on a wax model utilized in the lost wax investment casting technique, said slurry compromising the composition of claim 14.

22. A method for coating a wax model to form a shell utilizable in a lost wax investment casting technique, comprising coating the wax model with at least one prime coat of a water based slurry containing a colloidal silica of claim 14.
